(19) United States
(12) Patent Application Publication
(10) Pub. No.: US 2014/0044221 A1
(43) Pub. Date: Feb. 13, 2014

(54) DIGITAL RF RECEIVER

(71) Applicant: Electronics and Telecommunications Research Institute, Daejeon (KR)

(72) Inventors: Ik Soo EO, Daejeon (KR); Sang Kyun Kim, Mungyeong-si (KR); Seon Ho Han, Daejeon (KR)

(73) Assignee: Electronics and Telecommunications Research Institute, Daejeon (KR)

(21) Appl. No.: 13/960,555

(22) Filed: Aug. 6, 2013

(30) Foreign Application Priority Data
Aug. 8, 2012 (KR) 10-2012-0086998
Jun. 12, 2013 (KR) 10-2013-0067367

(51) Int. Cl. H04L 25/06

(52) U.S. Cl. CPC H04L 25/061
USPC 375/319; 375/316

(57) ABSTRACT

Embodiments provide a digital RF receiver including a signal converting unit which converts an RF signal received from an external device into a digital signal, a plurality of functional modules which processes the digital signal in accordance with a predetermined algorithm when the digital signal is input, and a signal processing controller which selects at least one of the plurality of functional modules to control the digital signal to be processed in consideration of whether an IF signal component is included in the digital signal or a sampling rate related with sampling information of the digital signal.

### CROSS-REFERENCE TO RELATED APPLICATIONS

This application claims priority to and the benefit of Korean Patent Application No. 10-2012-0086998 filed in the Korean Intellectual Property Office on Aug. 8, 2012, and Korean Patent Application No. 10-2013-0067367 filed in the Korean Intellectual Property Office on Jun. 12, 2013, the entire contents of which are incorporated herein by reference.

### TECHNICAL FIELD

Embodiments relate to a digital RF receiver, and more particularly, to a digital RF receiver which easily receives a multiple mode of a wireless mobile communication receiving terminal, an MIMO, and an RF signal which supports change in a bandwidth expansion.

### BACKGROUND ART

Generally, the RF receiver is a device which converts an RF signal received through an antenna into a signal band in which the RF signal is receivable at a lower level.

Such an RF receiver receives the RF signal through a duplexer and a mixer mixes an RF signal with a low noise amplified in a low noise amplifier and a local frequency supplied from a local frequency generator to generate an IF (intermediate frequency) signal and then pass only a desired band through a filter.

However, in the case of the RF receiver, when a new standard and a band and a bandwidth are newly added in accordance with the new standard, it needs lots of improvement time and cost to apply an RF receiving chip which is developed through new designing and manufacturing processes of an analog technology of the related art and manufacturing processes into a terminal.

Moreover, when a terminal which supports multiple modes is manufactured, a plurality of chips which supports individual standards is used in one terminal, which may increase a volume and a power consumption of the terminal.

Therefore, in recent years, studies are performed to develop an RF receiver which supports multiple mode reception, MIMO reception, and bandwidth expansion change using one RF receiving chip in one terminal.

### SUMMARY OF THE INVENTION

The present invention has been made in an effort to provide a digital RF receiver which increases a reception performance in accordance with a noise signal included in RF signals which are input in different positions for every functional block in accordance with a mode and a bandwidth and a sampling rate and reduces power consumption for multiple mode reception, MIMO reception, and bandwidth expansion reception.

An exemplary embodiment of the present invention provides a digital RF receiver including a signal converting unit which converts an RF signal received from an external device into a digital signal, a plurality of functional modules which processes the digital signal in accordance with a predetermined algorithm when the digital signal is input, and a signal processing controller which selects at least one of the plurality of functional modules to control the digital signal to be processed in consideration of whether an IF signal component is included in the digital signal or a sampling rate related with sampling information of the digital signal.

The digital RF receiver varies a signal processing order for the RF signal in accordance with an input signal condition of the RF signal when the RF signal is received to reduce the power consumption and processing time to process the RF signal.

Further, the digital RF receiver varies the signal processing order for the RF signal in accordance with the input signal condition of the RF signal when the RF signal is received, to increase a flexibility of the receiver using a multiple mode, a MIMO, a bandwidth expansion receiver, and a simultaneous multiple mode.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a control configuration of a digital RF receiver according to an exemplary embodiment.

FIGS. 2A and 2B are a block diagram of a control configuration of the digital RF receiver illustrated in FIG. 1 which is reconfigured according to a first exemplary embodiments.

FIGS. 3A and 3B are a block diagram of a control configuration of the digital RF receiver illustrated in FIG. 1 which is reconfigured according to a second exemplary embodiments.

FIGS. 4A and 4B are a block diagram of a control configuration of the digital RF receiver illustrated in FIG. 1 which is reconfigured according to a third exemplary embodiments.

FIGS. 5A and 5B are a block diagram of a control configuration of the digital RF receiver illustrated in FIG. 1 which is reconfigured according to a fourth exemplary embodiments.

FIGS. 6A and 6B are a block diagram of a control configuration of the digital RF receiver illustrated in FIG. 1 which is reconfigured according to a fifth exemplary embodiments.

FIGS. 7A and 7B are a block diagram of a control configuration of the digital RF receiver illustrated in FIG. 1 which is reconfigured according to a sixth exemplary embodiments.

FIG. 8 is a block diagram of a control configuration of the digital RF receiver illustrated in FIG. 1 which is reconfigured according to a seventh exemplary embodiment.

FIG. 9 is a block diagram of a control configuration of the digital RF receiver illustrated in FIG. 1 which is reconfigured according to an eighth exemplary embodiment.

FIGS. 10A and 10B are a block diagram of a control configuration of the digital RF receiver illustrated in FIG. 1 which is reconfigured according to a ninth exemplary embodiments.

FIGS. 11A and 11B are a block diagram of a control configuration of the digital RF receiver illustrated in FIG. 1 which is reconfigured according to a tenth exemplary embodiments.

FIGS. 12A and 12B are a block diagram of a control configuration of the digital RF receiver illustrated in FIG. 1 which is reconfigured according to an eleventh exemplary embodiments.

FIGS. 13A and 13B are a block diagram of a control configuration of the digital RF receiver illustrated in FIG. 1 which is reconfigured according to a twelfth exemplary embodiments.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The following description illustrates only a principle of the present invention. Therefore, those skilled in the art may implement the principle of the present invention and invent various apparatuses, which are included in a concept and a scope of the present invention, even though not clearly described or illustrated in the specification. It should be understood that all conditional terms and exemplary embodiments, which are described in the specification, are clearly intended only to understand the concept of the invention, but the present invention is not limited to the exemplary embodiments and states as described above.

Further, it should be understood that all detailed description, which specifies not only a principle, an aspect, and an exemplary embodiment, but also a specific exemplary embodiment, is intended to include structural and functional equivalents. It should be understood that such equivalents include all elements which are invented so as to perform the same function as the currently disclosed equivalents and equivalents, which will be developed in the future, regardless with the structure.

Therefore, for example, the block diagram of the present specification should be understood to represent an illustrative conceptual aspect which specifies the principle of the invention. Similarly, it should be understood that all of a flowchart, a status transitional view, and a pseudo code may be substantially represented in a computer readable medium and indicate various processes executed by a computer or a processor regardless of whether the computer or the processor is apparently illustrated.

Functions of various elements illustrated in the drawings including a functional block, which is represented by a processor or a concept similar thereto, may be provided by using not only an exclusive hardware but also a hardware which may execute a software with regard to an appropriate software. If the function is provided by the processor, the function may be provided by a single exclusive processor, a single shared processor or a plurality of individual processors, and some of them may be shared.

Further, a precise usage of a processor, control or a terminology suggested as a concept similar thereto should not be interpreted by exclusively citing hardware, which is capable of executing software, but should be understood to implicatively include a digital signal processor (DSP), and a ROM, a RAM, and a nonvolatile memory which store hardware and software without any restrictions. Widely known and commonly used other hardware may also be included therein.

In claims of this specification, components represented as means to perform the function described in the detailed description are intended to include, for example, a combination of circuit elements which perform the above-mentioned functions or all methods which performs functions including all types of software including a firmware/microcode, and are combined with an appropriate circuit which executes the software in order to perform the function. In the invention defined by the claims, the functions provided by the variously described means are combined with each other and combined with the method demanded by the claims so that any means which may provide the above-mentioned function should be understood to be equivalent to be understood from the specification.

The above objects, features, and advantages will be more obvious from the detailed description with reference to the accompanying drawings, and accordingly, those skilled in the art to which the invention pertains will be able to easily implement the technical spirit of the invention. However, in describing the present invention, if it is considered that description of a related known technology may unnecessarily cloud the gist of the present invention, the description thereof will be omitted.

Hereinafter, an exemplary embodiment of the present invention will be described in detail with reference to the accompanying drawings.

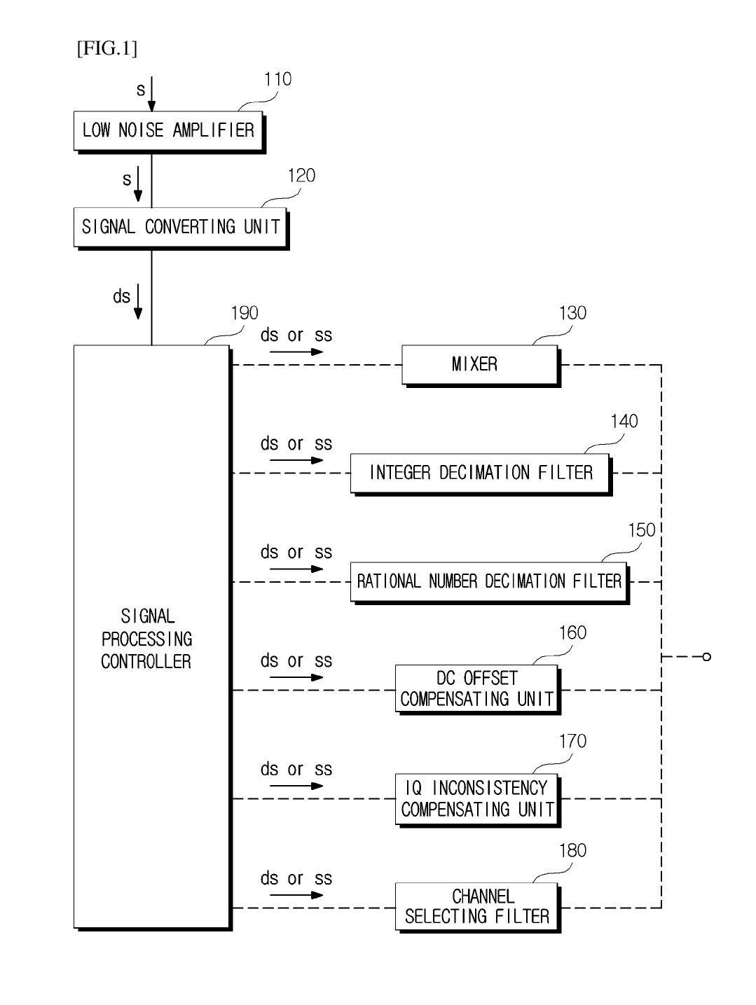

FIG. 1 is a block diagram illustrating a control configuration of a digital RF receiver according to an exemplary embodiment.

Referring to FIG. 1, the digital RF receiver may include a low noise amplifier 110, a signal converting unit 120, a plurality of functional modules (not illustrated), and a signal processing controller 190.

The low noise amplifier 110 amplifies an RF signal s which is received by an antenna (not illustrated) to have a predetermined amplitude.

Here, the low noise amplifier 110 suppresses the amplification of a noise component included in the RF signal s and adjusts an amplitude of the RF signal s to be output. In this case, the low noise amplifier 110 functions as a band limiting filter which removes the superposition of the noise component in the signal converting unit 120 in advance.

In the exemplary embodiment, the RF signal s has different bands and different bandwidths in accordance with the standards and may have multiple bands and bandwidths even in one standard, but the invention is not limited thereto. Further, the RF signal s may adopt a multiple antenna transceiving (MIMO) technique and a bandwidth expansion technique which simultaneously sends a signal to several bands in order to increase a signal transmission rate, but the invention is not limited thereto.

The signal converting unit 120 converts an RF signal s output from the low noise amplifier 110 into a digital signal ds.

And, the signal converting unit 120 may occur separated of an In-phase signal and a quadrature signal from the digital signal ds, but the invention is not limited thereto.

The plurality of functional modules may include a mixer 130, an integer decimation filter 140, a rational number decimation filter 150, a DC offset compensating unit 160, an IQ inconsistency compensating unit 170, and a channel selecting filter 180.

Here, when a digital signal ds is input, the mixer 130 may remove an IF (intermediate frequency) signal included in the digital signal ds and/or separate a phase.

The mixer 130 may occur separated of an In-phase signal and a quadrature signal from the digital signal ds and/or may be function a carrier shift of the digital signal ds.

The integer decimation filter 140 may perform integer decimation so as to satisfy an integer sampling rate which is required in an arbitrary standard which generates an RF signal s.

The rational number decimation filter 150 may perform rational number decimation so as to satisfy a rational number sampling rate which is required in an arbitrary standard.

When the digital signal ds is input, the DC offset compensating unit 160 may remove a DC component included in the digital signal ds.

Here, when the digital signal ds is input, the IQ inconsistency compensating unit 170 compensates a phase error of an In-phase signal and a quadrature signal from the digital signal ds.

When the digital signal ds is input, the channel selecting filter 180 may remove an interference signal in an adjacent band from the digital signal ds.

When the digital signal ds is input, the signal processing controller 190 selects at least one of the mixer 130, the integer decimation filter 140, the rational number decimation filter 150, the DC offset compensating unit 160, the IQ inconsistency compensating unit 170, and the channel selecting filter 180 in accordance with the input signal condition of the RF signal s to control the digital signal ds to be processed.

That is, the signal processing controller 190 inputs the digital signal ds to any one of the mixer 130, the integer decimation filter 140, the rational number decimation filter 150, the DC offset compensating unit 160, the IQ inconsistency compensating unit 170, and the channel selecting filter 180 and receives the digital signal ds output from the any one of the mixer 130, the integer decimation filter 140, a rational number decimation filter 150, the DC offset compensating unit 160, the IQ inconsistency compensating unit 170, and the channel selecting filter 180 to transmit the digital signal ds to another one and repeats the above operation selected at least two times to control the digital signal ds to be processed.

The digital RF receiver according to the exemplary embodiment is connected to the signal processing controller 190, separately from the mixer 130, the integer decimation filter 140, the rational number decimation filter 150, the DC offset compensating unit 160, the IQ inconsistency compensating unit 170, and the channel selecting filter 180 so that the signal processing controller 190 determines an order of processing the digital signal ds to control the digital signal ds to be processed.

In the exemplary embodiment, the arbitrary signal which is input to the mixer 130, the integer decimation filter 140, the rational number decimation filter 150, the DC offset compensating unit 160, the IQ inconsistency compensating unit 170, and the channel selecting filter 180 may be a digital signal ds output from the mixer 130, the integer decimation filter 140, the rational number decimation filter 150, the DC offset compensating unit 160, the IQ inconsistency compensating unit 170, and the channel selecting filter 180 but the invention is not limited thereto.

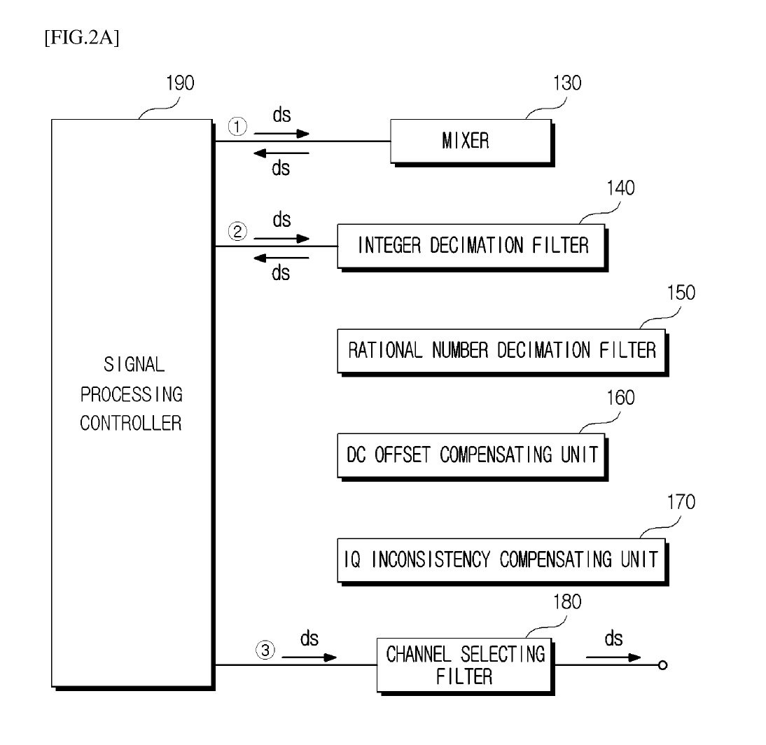

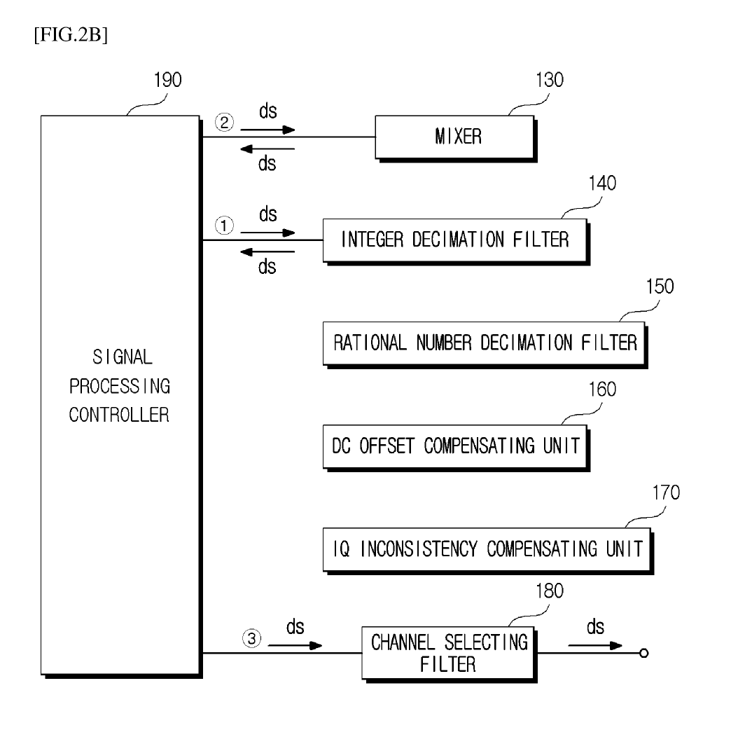

FIGS. 2A and 2B are a block diagram of a control configuration of the digital RF receiver illustrated in FIG. 1 which is reconfigured according to a first exemplary embodiments.

In FIGS. 2A and 2B, detailed description of repeated configurations of the configurations illustrated in FIG. 1 will be omitted or the repeated configuration will be briefly described.

Referring to FIGS. 2A and 2B, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least one of the mixer 130, the integer decimation filter 140, the rational number decimation filter 150, the DC offset compensating unit 160, the IQ inconsistency compensating unit 170, and the channel selecting filter 180 in accordance with an input signal condition of the digital signal ds to control the digital signal ds as illustrated in FIG. 1 to be processed.

Here, referring to FIG. 2A, in the input signal condition where the digital signal ds includes an IF signal and an integer sampling rate required in the arbitrary standard is not satisfied, the signal processing controller 190 selects the mixer 130, the integer decimation filter 140, and the channel selecting filter 180 to process the digital signal ds in accordance with a set signal processing order.

The signal processing controller 190 transmits the digital signal ds which is transmitted from the signal converting unit 120, to the mixer 130 from the mixer 130.

Further, the signal processing controller 190 transmits the digital signal ds, which is transmitted from the mixer 130, to the integer decimation filter 140 and receives an integer-decimated digital signal ds which satisfies the integer sampling rate required in an arbitrary standard from the integer decimation filter 140.

In this case, the signal processing controller 190 transmits the digital signal ds, which is transmitted from the integer decimation filter 140, to the channel selecting filter 180.

The channel selecting filter 180 outputs a digital signal ds obtained by removing an interference signal from the transmitted digital signal ds to a decoder (not illustrated) or other processing device.

Here, the interference signal may be an original noise signal of and an inflow noise signal in at least one of the mixer 130, the integer decimation filter 140, and the signal processing controller 190, but the invention is not limited thereto. The original noise signal included in the RF signal.

Here, referring to FIG. 2B, in the input signal condition where the digital signal ds includes an IF signal and an integer sampling rate required in the arbitrary standard is not satisfied, the signal processing controller 190 selects the integer decimation filter 140, the mixer 130, and the channel selecting filter 180 to process the digital signal ds in accordance with a set signal processing order.

That is, FIG. 2B illustrates a different signal processing order in the input signal condition which is the same as FIG. 2A.

Differently from FIG. 2A, in FIG. 2B, after performing the integer decimation on a digital signal ds first in the integer decimation filter 140, the IF signal is removed to separate a phase in the mixer 130 and then the digital signal is transmitted to the channel selecting filter 180.

In FIGS. 2A and 2B, the signal processing controller 190 selects the mixer 130, the integer decimation filter 140, and the channel selecting filter 180 and inputs the digital signal ds to the mixer 130, the integer decimation filter 140, and the channel selecting filter 180. However, the signal processing controller 190 may input the digital signal ds to any one of the mixer 130, the integer decimation filter 140, and the channel selecting filter 180 to control the digital signal ds to be continuously input in accordance with the predetermined signal processing order.

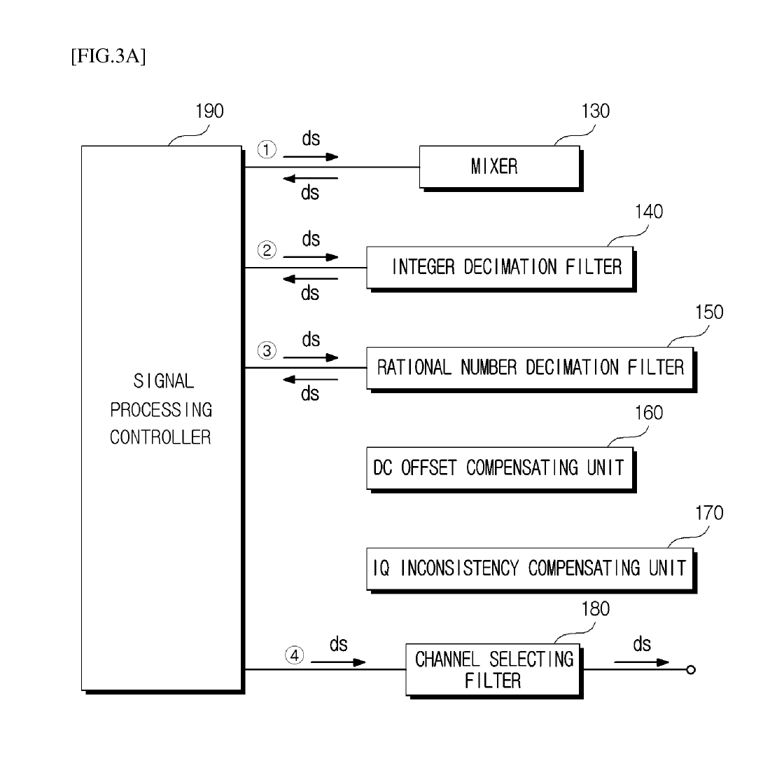

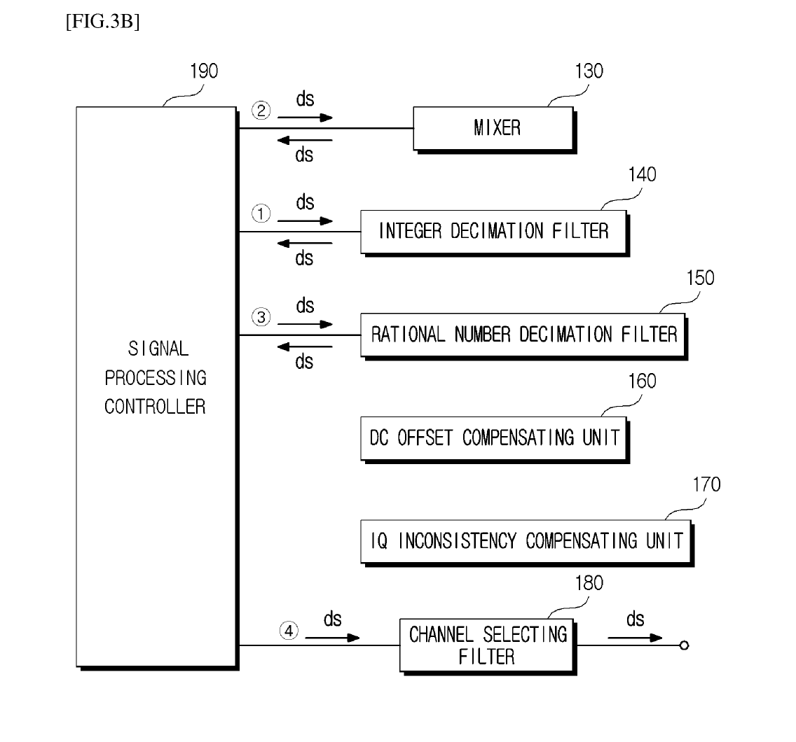

FIGS. 3A and 3B are a block diagram of a control configuration of the digital RF receiver illustrated in FIG. 1 which is reconfigured according to a second exemplary embodiments.

In FIGS. 3A and 3B, detailed description of repeated configurations of the configurations illustrated in FIG. 1 will be omitted or the repeated configurations will be briefly described.

Referring to FIGS. 3A and 3B, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least one of the mixer 130, the integer decimation filter 140, the rational number decimation filter 150, the DC offset compensating unit 160, the IQ inconsistency compensating unit 170, and the channel selecting filter 180 in accordance with an input signal condition of the digital signal ds illustrated in FIG. 1 to control the digital signal ds to be processed.

Here, referring to FIG. 3A, in the input signal condition where the digital signal ds includes an IF signal and a rational number sampling rate required in the arbitrary standard is not satisfied, the signal processing controller 190 selects the mixer 130, the integer decimation filter 140, the rational number decimation filter 150, and the channel selecting filter 180 to process the digital signal ds in accordance with a set signal processing order.

The signal processing controller 190 transmits the digital signal ds which is transmitted from the signal converting unit 120 to the mixer 130 and receives the digital signal ds in which the IF signal included in the digital signal ds is removed and/or a phase is separated, from the mixer 130.

Further, the signal processing controller 190 transmits the digital signal ds, which is transmitted from the mixer 130, to the integer decimation filter 140 and receives an integer-decimated digital signal ds which satisfies the integer sampling rate required in an arbitrary standard from the integer decimation filter 140.

Thereafter, the signal processing controller 190 transmits the digital signal ds, which is transmitted from the integer decimation filter 140, to the rational number decimation filter 150 and the rational number decimation filter 150 transmits the rational number-decimated digital signal ds to the signal processing controller 190.

In this case, the signal processing controller 190 transmits the digital signal ds, which is transmitted from the rational number decimation filter 150, to the channel selecting filter 180.

The channel selecting filter 180 outputs a digital signal ds obtained by removing an interference signal to other processing device.

Here, the interference signal may be a noise signal which is flew in the digital signal ds from at least one of the mixer 130, the integer decimation filter 140, the rational number decimation filter 150, and the signal processing controller 190.

Also, the interference signal may be an original noise signal included in the RF signal, but the invention is not limited thereto.

Here, referring to FIG. 3B, in the input signal condition where the digital signal ds includes an IF signal and an integer sampling rate required in the arbitrary standard is not satisfied, the signal processing controller 190 selects the integer decimation filter 140, the mixer 130, the rational number decimation filter 150, and the channel selecting filter 180 to process the digital signal ds in accordance with a set signal processing order.

That is, FIG. 3B illustrates a different signal processing order in the input signal condition which is the same as FIG. 3A.

Differently from FIG. 3A, in FIG. 3B, after performing the integer decimation on a digital signal ds first in the integer decimation filter 140, the IF signal is removed to separate a phase in the mixer 130, the digital signal is rational number-decimated in the rational number decimation filter 150, and then is transmitted to the channel selecting filter 180.

In FIGS. 3A and 3B, even though it is described that the mixer 130, the integer decimation filter 140, the rational number decimation filter 150, and the channel selecting filter 180 receive the digital signal ds through the signal processing controller 190, the signal processing controller 190 does not receive the digital signal ds output from at least one of the mixer 130, the integer decimation filter 140, the rational number decimation filter 150, and the channel selecting filter 180, but controls the digital signal ds to be automatically transmitted to the mixer 130, the integer decimation filter 140, the rational number decimation filter 150, and the channel selecting filter 180 in accordance with the set signal processing order. However, the invention is not limited thereto.

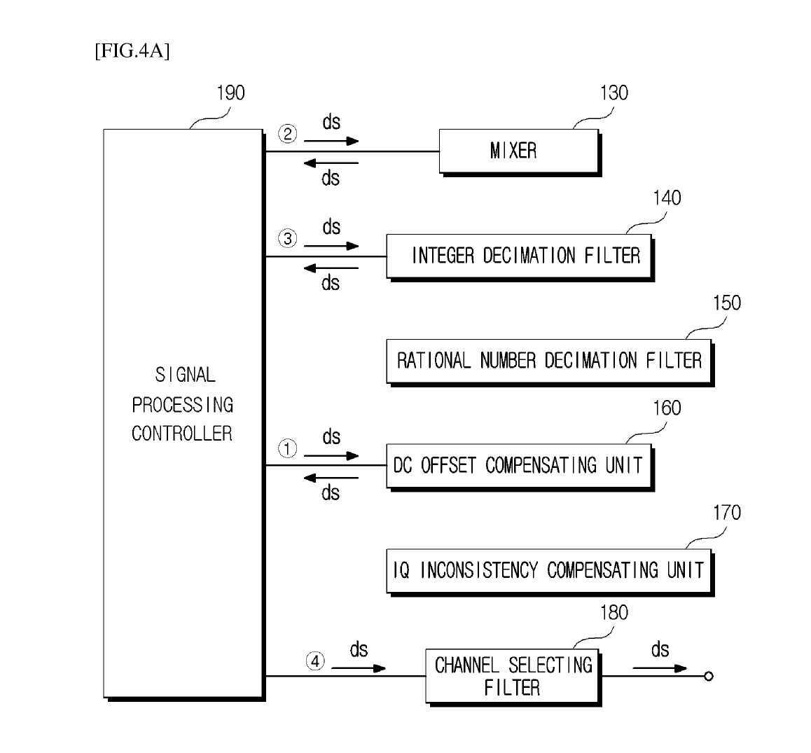

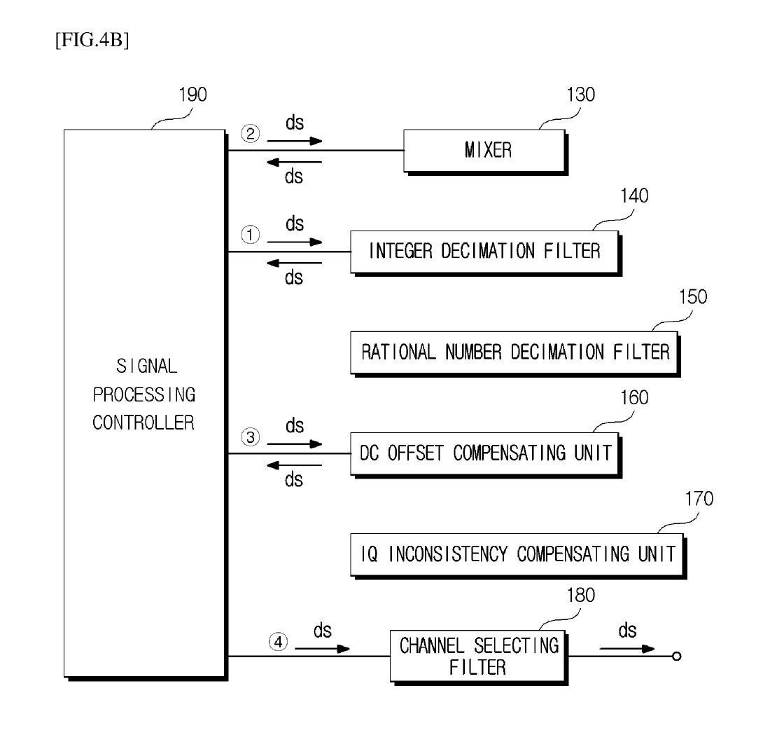

FIGS. 4A and 4B are a block diagram of a control configuration of the digital RF receiver illustrated in FIG. 1 which is reconfigured according to a third exemplary embodiments.

In FIGS. 4A and 4B, detailed description of repeated configurations of the configurations illustrated in FIG. 1 will be omitted or the repeated configurations will be briefly described.

Referring to FIGS. 4A and 4B, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least one of the mixer 130, the integer decimation filter 140, the rational number decimation filter 150, the DC offset compensating unit 160, the IQ inconsistency compensating unit 170, and the channel selecting filter 180 in accordance with an input signal condition of the digital signal ds illustrated in FIG. 1 to control the digital signal ds to be processed.

Here, referring to FIG. 4A, in the input signal condition where the digital signal ds includes an IF signal and a DC component and an integer sampling rate required in the arbitrary standard is not satisfied, the signal processing controller 190 selects the DC offset compensating unit 160, the mixer 130, the integer decimation filter 140, and the channel selecting filter 180 to process the digital signal ds in accordance with a set signal processing order.

The signal processing controller 190 transmits the digital signal ds, which is transmitted from the signal converting unit 120, to the DC offset compensating unit 160 and the DC offset compensating unit 160 transmits a digital signal ds in which a DC component included in the digital signal ds is removed to the signal processing controller 190.

The signal processing controller 190 transmits the digital signal ds, which is transmitted from the DC offset compensating unit 160, to the mixer 130 and receives the digital signal ds in which the IF signal included in the digital signal ds is removed and/or a phase is separated, from the mixer 130.

Further, the signal processing controller 190 transmits the digital signal ds, which is transmitted from the mixer 130, to the integer decimation filter 140 and receives an integer-decimated digital signal ds which satisfies the integer sampling rate required in an arbitrary standard from the integer decimation filter 140.

Thereafter, the signal processing controller 190 transmits the digital signal ds, which is transmitted from the integer decimation filter 140, to the channel selecting filter 180.

The channel selecting filter 180 outputs a digital signal ds obtained by removing an interference signal to other processing device.

Here, the interference signal may be a noise signal which is flew in the digital signal ds from at least one of the mixer 130, the integer decimation filter 140, the DC offset compensating unit 160, and the signal processing controller 190.

Also, the interference signal may be an original noise signal included in the RF signal, but the invention is not limited thereto.

Here, referring to FIG. 4B, in the input signal condition where the digital signal ds includes an IF signal and a DC component and an integer sampling rate required in the arbitrary standard is not satisfied, the signal processing controller 190 selects the integer decimation filter 140, the mixer 130, the DC offset compensating unit 160, and the channel selecting filter 180 to process the digital signal ds in accordance with a set signal processing order.

That is, FIG. 4B illustrates a different signal processing order in the input signal condition which is the same as FIG. 4A.

Differently from FIG. 4A, in FIG. 4B, after performing the integer decimation on a digital signal ds first in the integer decimation filter 140, the IF signal is removed in the mixer 130, and then the digital signal ds in which the DC component included in the digital signal ds is removed first in the DC offset compensating unit 160 is transmitted to the channel selecting filter 180.

In FIGS. 4A and 4B, even though it is described that the mixer 130, the integer decimation filter 140, the DC offset compensating unit 160, and the channel selecting filter 180 receive the digital signal ds through the signal processing controller 190, the signal processing controller 190 does not receive the digital signal ds output from at least one of the mixer 130, the integer decimation filter 140, the DC offset compensating unit 160, and the channel selecting filter 180, but controls the digital signal to be automatically transmitted to the mixer 130, the integer decimation filter 140, the DC offset compensating unit 160, and the channel selecting filter 180 in accordance with the set signal processing order However, the invention is not limited thereto.

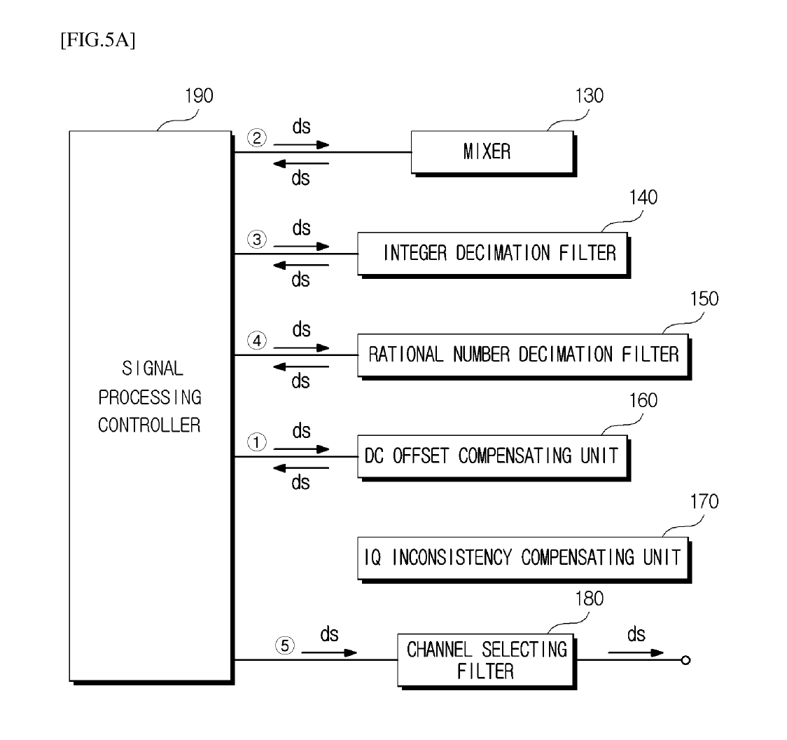

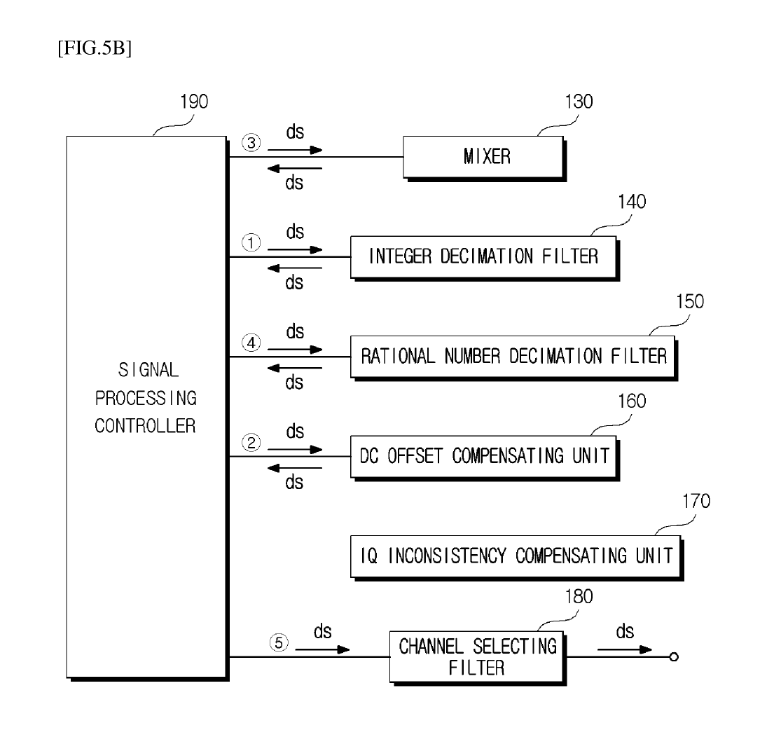

FIGS. 5A and 5B are a control block diagram of a control configuration of the digital RF receiver illustrated in FIG. 1 which is reconfigured according to a fourth exemplary embodiments.

In FIGS. 5A and 5B, detailed description of repeated configurations of the configurations illustrated in FIG. 1 will be omitted or repeated configurations will be briefly described.

Referring to FIGS. 5A and 5B, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least one of the mixer 130, the integer decimation filter 140, the rational number decimation filter 150, the DC offset compensating unit 160, the IQ inconsistency compensating unit 170, and the channel selecting filter 180 in accordance with an input signal condition of the digital signal ds illustrated in FIG. 1 to control the digital signal ds to be processed.

Here, referring to FIG. 5A, in the input signal condition where the digital signal ds includes an IF signal and the DC component and a rational number sampling rate required in the arbitrary standard is not satisfied, the signal processing controller 190 selects the DC offset compensating unit 160, the mixer 130, the integer decimation filter 140, the rational number decimation filter 150, and the channel selecting filter 180 to process the digital signal ds in accordance with a set signal processing order.

The signal processing controller 190 transmits the digital signal ds, which is transmitted from the signal converting unit 120, to the DC offset compensating unit 160 and the DC offset compensating unit 160 transmits a digital signal ds in which a DC component included in the digital signal ds is removed to the signal processing unit 190.

The signal processing controller 190 transmits the digital signal ds, which is transmitted from the DC offset compensating unit 160, to the mixer 130, and receives the digital signal ds in which the IF signal included in the digital signal ds is removed and a phase is separated, from the mixer 130.

Further, the signal processing controller 190 transmits the digital signal ds, which is transmitted from the mixer 130, to the integer decimation filter 140 and receives an integer-decimated digital signal ds which satisfies the integer sampling rate required in an arbitrary standard from the integer decimation filter 140.

Thereafter, the signal processing controller 190 transmits the digital signal ds, which is transmitted from the integer decimation filter 140, to the rational number decimation filter 150 and the rational number decimation filter 150 receives the rational number-decimated digital signal ds.

The signal processing controller 190 transmits the digital signal ds, which is transmitted from the rational number decimation filter 150, to the channel selecting filter 180.

The channel selecting filter 180 outputs a digital signal ds obtained by removing an interference signal to other processing device.

Here, the interference signal may be a noise signal which is flew in the digital signal ds from at least one of the mixer 130, the integer decimation filter 140, the DC offset compensating unit 160, the rational number decimation filter 150, and the signal processing controller 190.

Also, the interference signal may be an original noise signal included in the RF signal, but the invention is not limited thereto.

Here, referring to FIG. 5B, in the input signal condition where the digital signal ds includes an IF signal and a DC component and an integer sampling rate required in the arbitrary standard is not satisfied, the signal processing controller 190 selects the integer decimation filter 160, the mixer 130, the DC offset compensating unit 160, and the channel selecting filter 180 to process the digital signal ds in accordance with a set signal processing order.

That is, FIG. 5B illustrates a different signal processing order in the input signal condition which is the same as FIG. 5A.

Differently from FIG. 5A, in FIG. 5B, the integer decimation is performed on a digital signal ds first in the integer decimation filter 140, the DC component is removed in the DC offset compensating unit 160, the IF signal is removed in the mixer 130 so that a digital signal ds is rational number-decimated in the rational number decimation filter 150, and then is transmitted to the channel selecting filter 180.

In FIGS. 5A and 5B, even though it is described that the mixer 130, the integer decimation filter 140, the rational number decimation filter 150, the DC offset compensating unit 160, and the channel selecting filter 180 receive the digital signal ds through the signal processing controller 190, the signal processing controller 190 does not receive the digital signal ds output from at least one of the mixer 130, the integer decimation filter 140, the rational number decimation filter 150, the DC offset compensating unit 160, and the channel selecting filter 180, but controls the digital signal to be automatically transmitted to the mixer 130, the integer decimation filter 140, the rational number decimation filter 150, the DC offset compensating unit 160, and the channel selecting filter 180 in accordance with the set signal processing order. However, the invention is not limited thereto.

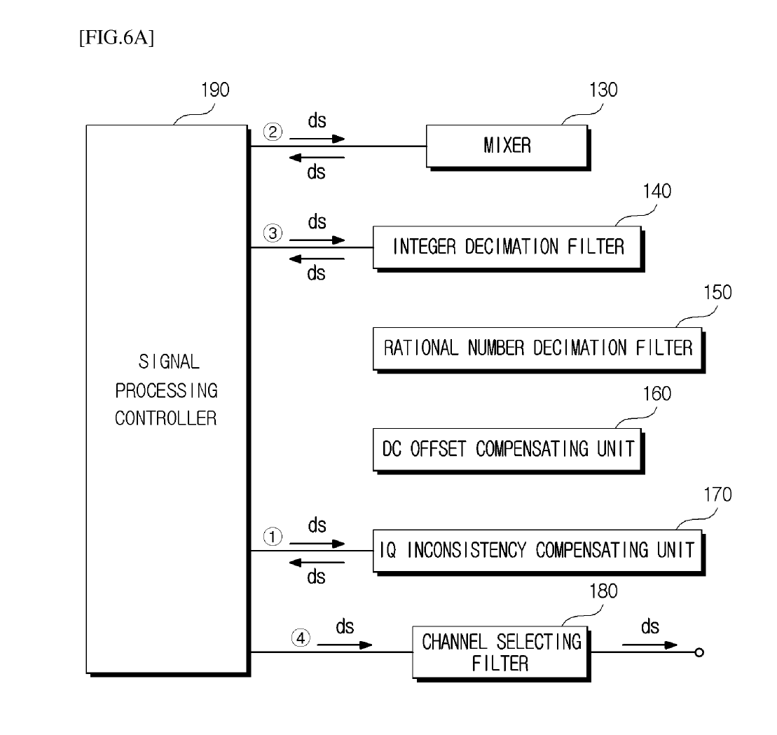

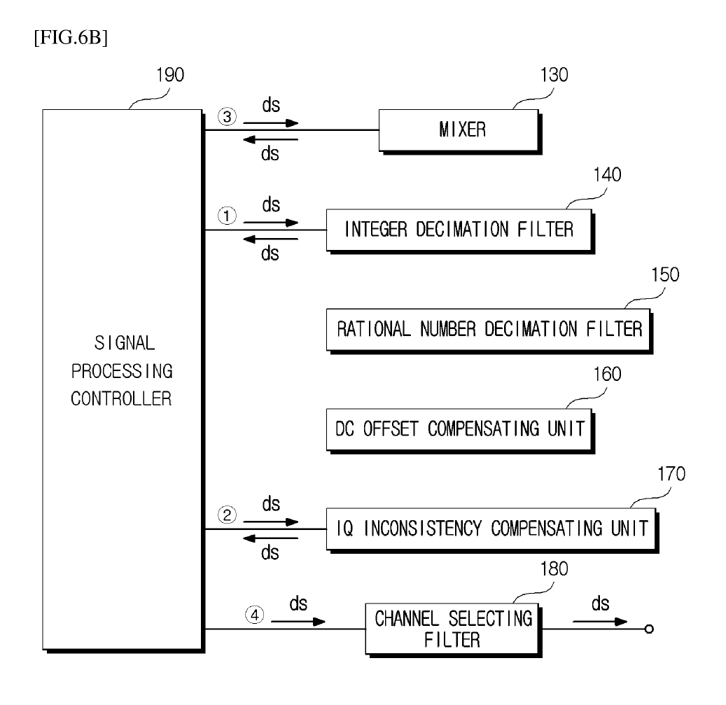

FIGS. 6A and 6B are a control block diagram of a control configuration of the digital RF receiver illustrated in FIG. 1 which is reconfigured according to a fifth exemplary embodiments.

In FIGS. 6A and 6B, detailed description of repeated configurations of the configurations illustrated in FIG. 1 will be omitted or repeated configurations will be briefly described.

Referring to FIGS. 6A and 6B, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least one of the mixer 130, the integer decimation filter 140, the rational number decimation filter 150, the DC offset compensating unit 160, the IQ inconsistency compensating unit 170, and the channel selecting filter 180 in accordance with an input signal condition of the digital signal ds illustrated in FIG. 1 to control the digital signal ds to be processed. Here, referring to FIG. 6A, in the input signal condition where the digital signal ds includes an IF signal, the IQs are inconsistent, and an integer sampling rate required in the arbitrary standard is not satisfied, the signal processing controller 190 selects the mixer 130, the integer decimation filter 140, the IQ inconsistency compensating unit 170, and the channel selecting filter 180 to process the digital signal ds in accordance with a set signal processing order.

The signal processing controller 190 transmits the digital signal ds, which is transmitted from the signal converting unit 120, to the IQ inconsistency compensating unit 170 and the IQ inconsistency compensating unit 170 transmits a digital signal ds in which a phase error of an In-phase signal and a quadrature signal is compensated in the digital signal ds to the signal processing controller 190.

The signal processing controller 190 transmits the digital signal ds, which is transmitted from the IQ inconsistency compensating unit 170, to the mixer 130 and receives the digital signal ds in which the IF signal included in the digital signal ds is removed and/or a phase is separated, from the mixer 130.

Further, the signal processing controller 190 transmits the digital signal ds, which is transmitted from the mixer 130, to the integer decimation filter 140 and receives an integer-decimated digital signal ds which satisfies the integer sampling rate required in an arbitrary standard from the integer decimation filter 140.

Thereafter, the signal processing controller 190 transmits the digital signal ds, which is transmitted from the integer decimation filter 140, to the channel selecting filter 180.

The channel selecting filter 180 outputs a digital signal ds obtained by removing an interference signal to other processing device.

Here, the interference signal may be a noise signal which is flew in the digital signal ds from at least one of the mixer 130, the integer decimation filter 140, the IQ inconsistency compensating unit 170, and the signal processing controller 190.

Also, the interference signal may be an original noise signal included in the RF signal, but the invention is not limited thereto.

Here, referring to FIG. 6B, in the input signal condition in which the digital signal ds includes an IF signal, the IQs are inconsistent, and an integer sampling rate required in the arbitrary standard is not satisfied, the signal processing controller 190 selects the integer decimation filter 140, the mixer 130, the IQ inconsistency compensating unit 170, and the channel selecting filter 180 to process the digital signal ds in accordance with a set signal processing order.

That is, FIG. 6B illustrates a different signal processing order in the input signal condition which is the same as FIG. 6A.

Differently from FIG. 6A, in FIG. 6B, the integer decimation is performed in the integer decimation filter 140, the IQ inconsistency compensating unit 170 transmits a digital signal ds in which a phase error of an In-phase signal and the quadrature signal is compensated to the mixer 130, and the IF signal is removed in the mixer 130 to transmit the digital signal ds to the channel selecting filter 180.

In FIGS. 6A and 6B, even though it is described that the mixer 130, the integer decimation filter 140, the IQ inconsistency compensating unit 170, and the channel selecting filter 180 receive the digital signal ds through the signal processing controller 190, the signal processing controller 190 does not receive the digital signal ds output from at least one of the mixer 130, the integer decimation filter 140, the IQ inconsistency compensating unit 170, and the channel selecting filter 180, but controls the digital signal to be automatically transmitted to the mixer 130, the integer decimation filter 140, the IQ inconsistency compensating unit 170, and the channel selecting filter 180 in accordance with the set signal processing order. However, the invention is not limited thereto.

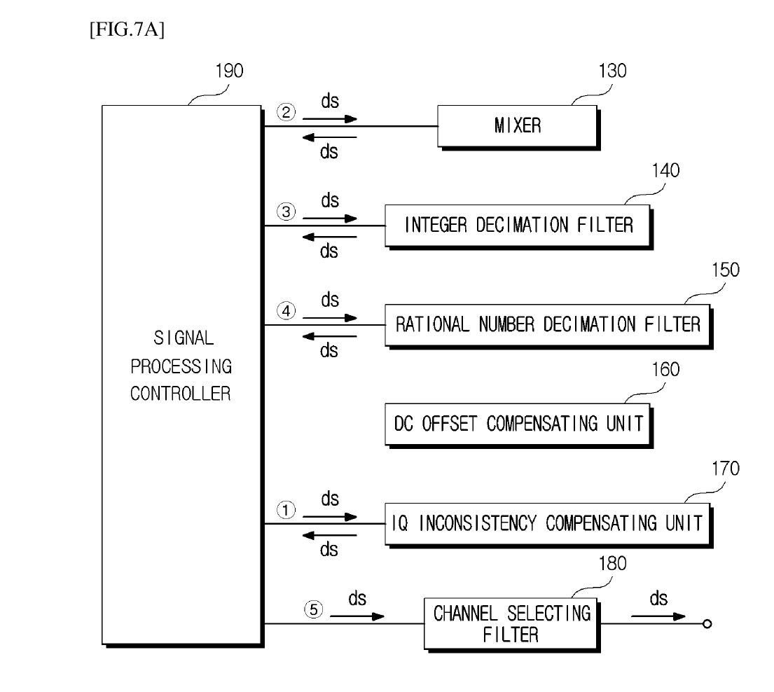

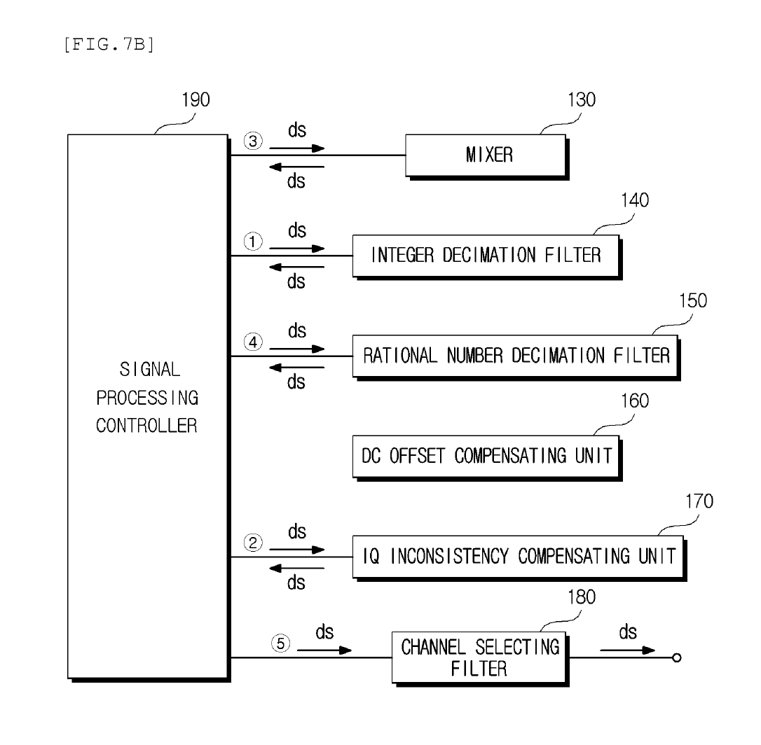

FIGS. 7A and 7B are a control block diagram of a control configuration of the digital RF receiver illustrated in FIG. 1 which is reconfigured according to a sixth exemplary embodiments.

In FIGS. 7A and 7B, detailed description of repeated configurations of the configurations illustrated in FIG. 1 will be omitted or the repeated configurations will be briefly described.

Referring to FIGS. 7A and 7B, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least one of the mixer 130, the integer decimation filter 140, the rational number decimation filter 150, the DC offset compensating unit 160, the IQ inconsistency compensating unit 170, and the channel selecting filter 180 in accordance with an input signal condition of the digital signal ds illustrated in FIG. 1 to control the digital signal ds to be processed.

Here, referring to FIG. 7A, in the input signal condition where the digital signal ds includes an IF signal, the IQs are inconsistent, and a rational number sampling rate required in the arbitrary standard is not satisfied, the signal processing controller 190 selects the mixer 130, the integer decimation filter 140, the rational number decimation filter 150, the IQ inconsistency compensating unit 170, and the channel selecting filter 180 to process the digital signal ds in accordance with a set signal processing order.

The signal processing controller 190 transmits the digital signal ds, which is transmitted from the signal converting unit 120, to the IQ inconsistency compensating unit 170 and the IQ inconsistency compensating unit 170 transmits a digital signal ds in which a phase error of an In-phase signal and a quadrature signal is compensated in the digital signal ds to the signal processing controller 190.

The signal processing controller 190 transmits the digital signal ds, which is transmitted from the IQ inconsistency compensating unit 170, to the mixer 130 and receives the digital signal ds in which the IF signal included in the digital signal ds is removed and/or a phase is separated, from the mixer 130.

Further, the signal processing controller 190 transmits the digital signal ds, which is transmitted from the mixer 130, to the integer decimation filter 140 and receives an integer-decimated digital signal ds which satisfies the integer sampling rate required in an arbitrary standard from the integer decimation filter 140.

Thereafter, the signal processing controller 190 transmits the digital signal ds, which is transmitted from the integer decimation filter 140, to the rational number decimation filter 150.

The rational number decimation filter 150 performs the rational number decimation on the digital signal ds to transmit the rational number-decimated digital signal to the signal processing controller 190 and the signal processing controller 190 transmits the digital signal ds transmitted from the rational number decimation filter 160 to the channel selecting filter 180.

The channel selecting filter 180 outputs a digital signal ds obtained by removing an interference signal to other processing device.

Here, the interference signal may be a noise signal which is flew in the digital signal ds from at least one of the mixer 130, the integer decimation filter 140, the rational number decimation filter 150, the IQ inconsistency compensating unit 170, and the signal processing controller 190.

Also, the interference signal may be an original noise signal included in the RF signal, but the invention is not limited thereto.

Here, referring to FIG. 7B, in the input signal condition in which the digital signal ds includes an IF signal, the IQs are inconsistent, and a rational number sampling rate required in the arbitrary standard is not satisfied, the signal processing controller 190 selects the integer decimation filter 140, the mixer 130, the rational number decimation filter 150, the IQ inconsistency compensating unit 170, and the channel selecting filter 180 to process the digital signal ds in accordance with a set signal processing order.

That is, FIG. 7B illustrates a different signal processing order in the input signal condition which is the same as FIG. 7A.

Differently from FIG. 7A, in FIG. 7B, the integer decimation is performed on the digital signal ds in the integer decimation filter 140, the digital signal ds in which a phase error of an In-phase signal and the quadrature signal is compensated in the IQ inconsistency compensating unit 170, and the digital signal ds in which the IF signal is removed from the mixer 130 is rational number-decimated in the rational number decimation filter 150 and then transmitted to the channel selecting filter 180.

In FIGS. 7A and 7B, even though it is described that the mixer 130, the integer decimation filter 140, the rational number decimation filter 150, the IQ inconsistency compensating unit 170, and the channel selecting filter 180 receive the digital signal ds through the signal processing controller 190, the signal processing controller 190 does not receive the digital signal ds output from at least one of the mixer 130, the integer decimation filter 140, the rational number decimation filter 150, the IQ inconsistency compensating unit 170, and the channel selecting filter 180, but controls the digital signal to be automatically transmitted to the mixer 130, the integer decimation filter 140, the rational number decimation filter 150, the IQ inconsistency compensating unit 170, and the channel selecting filter 180 in accordance with the set signal processing order. However, the invention is not limited thereto.

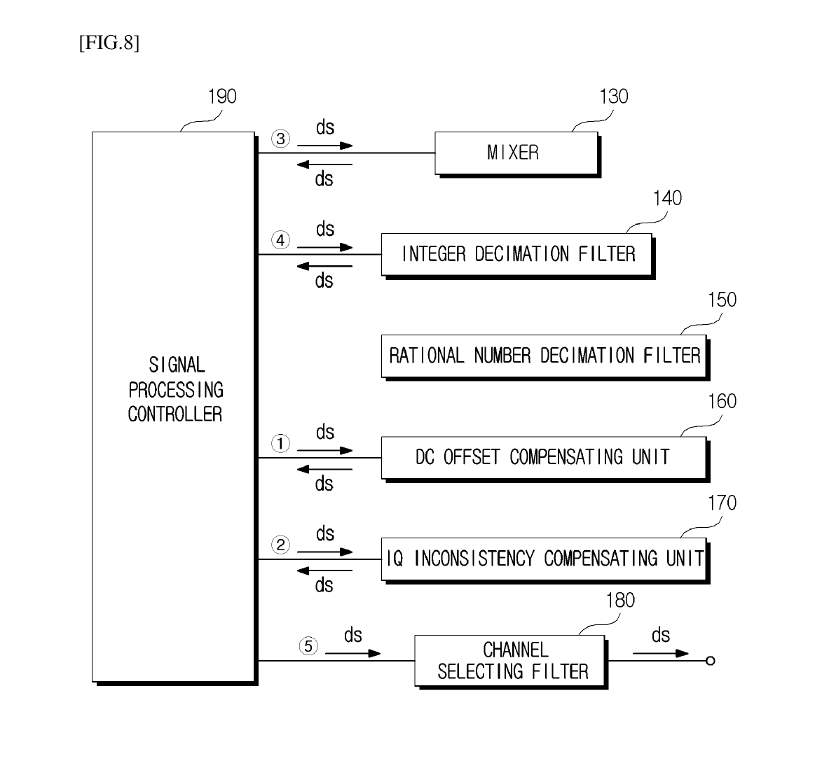

FIG. 8 is a control block diagram of a control configuration of the digital RF receiver illustrated in FIG. 1 which is reconfigured according to a seventh exemplary embodiment.

In FIG. 8, detailed description of repeated configurations of the configurations illustrated in FIG. 1 will be omitted or the repeated configurations will be briefly described.

Referring to FIG. 8, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least one of, the integer decimation filter 140, the rational number decimation filter 150, the DC offset compensating unit 160, the IQ inconsistency compensating unit 170, and the channel selecting filter 180 in accordance with an input signal condition of the digital signal ds illustrated in FIG. 1 to control the digital signal ds to be processed.

Here, referring to FIG. 8, in the input signal condition where the digital signal ds includes an IF signal and a DC component, the IQs are inconsistent, and an integer sampling rate required in the arbitrary standard is not satisfied, the signal processing controller 190 selects the mixer 130, the integer decimation filter 140, the DC offset compensating unit 160, the IQ inconsistency compensating unit 170, and the channel selecting filter 180 to process the digital signal ds in accordance with a set signal processing order.

The signal processing controller 190 transmits the digital signal ds, which is transmitted from the signal converting unit 120, to the DC offset compensating unit 160 and the DC offset compensating unit 160 transmits a digital signal ds in which a DC component included in the digital signal ds is removed to the signal processing controller 190.

The signal processing controller 190 transmits the digital signal ds, which is transmitted from the DC offset compensating unit 160, to the IQ inconsistency compensating unit 170 and the IQ inconsistency compensating unit 170 transmits a digital signal ds in which a phase error of an In-phase signal and a quadrature signal is compensated in the digital signal ds to the signal processing controller 190.

The signal processing controller 190 transmits the digital signal ds, which is transmitted from the IQ inconsistency compensating unit 170, to the mixer 130 and receives the digital signal ds in which the IF signal included in the digital signal ds is removed, from the mixer 130.

Further, the signal processing controller 190 transmits the digital signal ds, which is transmitted from the mixer 130, to the integer decimation filter 140 and receives an integer-decimated digital signal ds which satisfies the integer sampling rate required in an arbitrary standard from the integer decimation filter 140.

Thereafter, the signal processing controller 190 transmits the digital signal ds, which is transmitted from the integer decimation filter 140, to the channel selecting filter 180.

The channel selecting filter 180 outputs a digital signal ds obtained by removing an interference signal to other processing device.

Here, the interference signal may be a noise signal which is flew in the digital signal ds from at least one of the mixer 130, the integer decimation filter 140, the IQ inconsistency compensating unit 170, and the signal processing controller 190.

Also, the interference signal may be an original noise signal included in the RF signal, but the invention is not limited thereto.

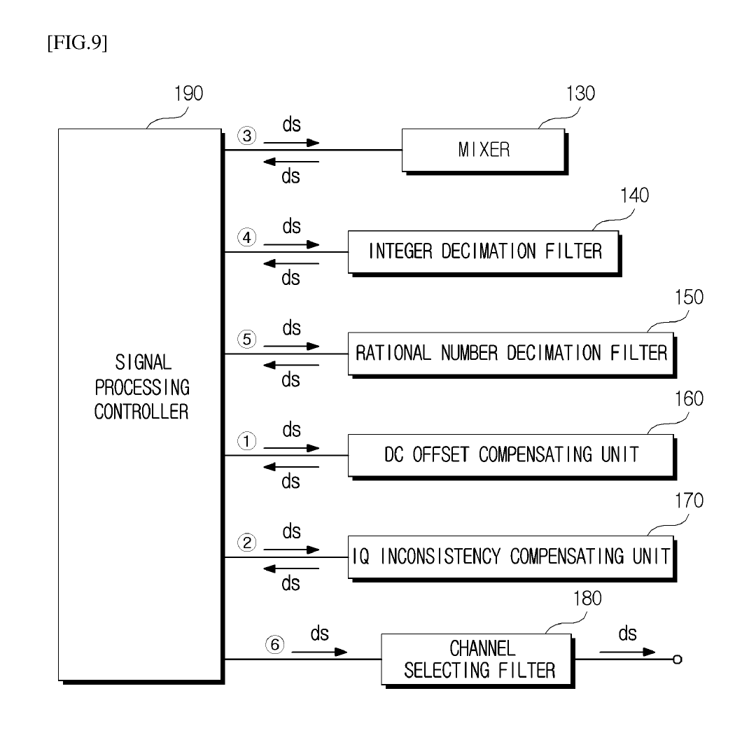

FIG. 9 is a control block diagram of a control configuration of the digital RF receiver illustrated in FIG. 1 which is reconfigured according to an eighth exemplary embodiment.

In FIG. 9, detailed description of repeated configurations of the configurations illustrated in FIG. 1 will be omitted or the repeated configurations will be briefly described.

Referring to FIG. 9, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least two of the low noise amplifier 110, the signal converting unit 120, the mixer 130, the integer decimation filter 140, the rational number decimation filter 150, the DC offset compensating unit 160, the IQ inconsistency compensating unit 170, and the channel selecting filter 180 in accordance with an input signal condition of the digital signal ds illustrated in FIG. 1 to control the digital signal ds to be processed.

Here, referring to FIG. 9, in the input signal condition where the digital signal ds includes an IF signal and a DC component, the IQs are inconsistent, and a rational number sampling rate required in the arbitrary standard is not satisfied, the signal processing controller 190 selects the mixer 130, the integer decimation filter 140, the rational number decimation filter 150, the DC offset compensating unit 160, the IQ inconsistency compensating unit 170, and the channel selecting filter 180 to process the digital signal ds in accordance with a set signal processing order.

The signal processing controller 190 transmits the digital signal ds, which is transmitted from the signal converting unit 120, to the DC offset compensating unit 160 and the DC offset compensating unit 160 transmits a digital signal ds in which a DC component included in the digital signal ds is removed to the signal processing controller 190.

The signal processing controller 190 transmits the digital signal ds, which is transmitted from the DC offset compensating unit 160, to the IQ inconsistency compensating unit 170 and the IQ inconsistency compensating unit 170 transmits a digital signal ds in which a phase error of an In-phase signal and a quadrature signal is compensated in the digital signal to the signal processing controller 190.

The signal processing controller 190 transmits the digital signal ds, which is transmitted from the IQ inconsistency compensating unit 170, to the mixer 130 and receives the digital signal ds in which the IF signal included in the digital signal ds is removed, from the mixer 130.

Further, the signal processing controller 190 transmits the digital signal ds, which is transmitted from the mixer 130, to the integer decimation filter 140 and receives an integer-decimated digital signal ds which satisfies the integer sampling rate required in an arbitrary standard from the integer decimation filter 140.

Thereafter, the signal processing controller 190 transmits the digital signal ds, which is transmitted from the integer decimation filter 140, to the rational number decimation filter 150.

The rational number decimation filter 150 transmits a rational number decimated digital signal ds in which the digital signal ds satisfies the rational number sampling rate required in the arbitrary standard to the signal processing controller 190.

The signal processing controller 190 transmits the digital signal ds, which is transmitted from the rational number decimation filter 150, to the channel selecting filter 180.

The channel selecting filter 180 outputs a digital signal ds obtained by removing an interference signal to other processing device.

Here, the interference signal may be a noise signal which is flew in the digital signal ds from at least one of the mixer 130, the integer decimation filter 140, the IQ inconsistency compensating unit 170, and the signal processing controller 190.

Also, the interference signal may be an original noise signal included in the RF signal, but the invention is not limited thereto.

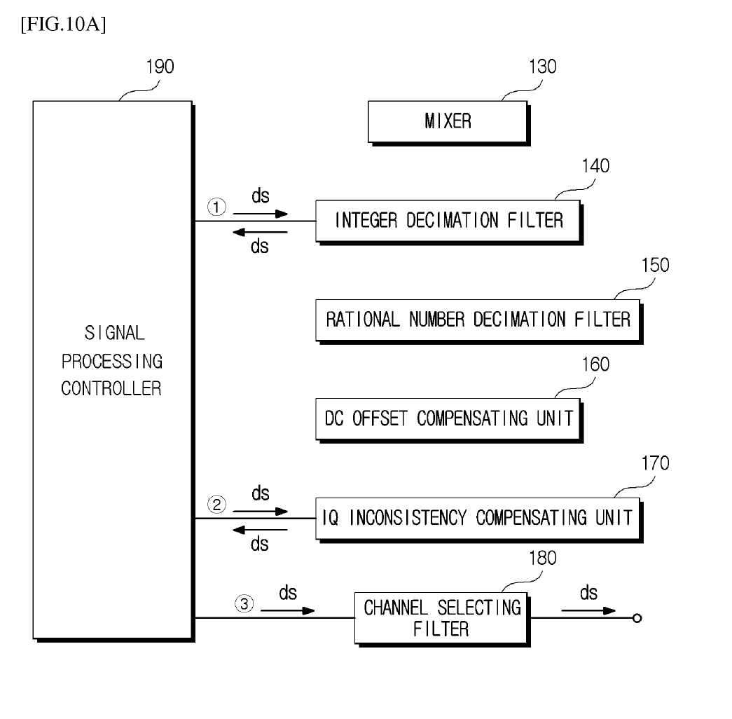

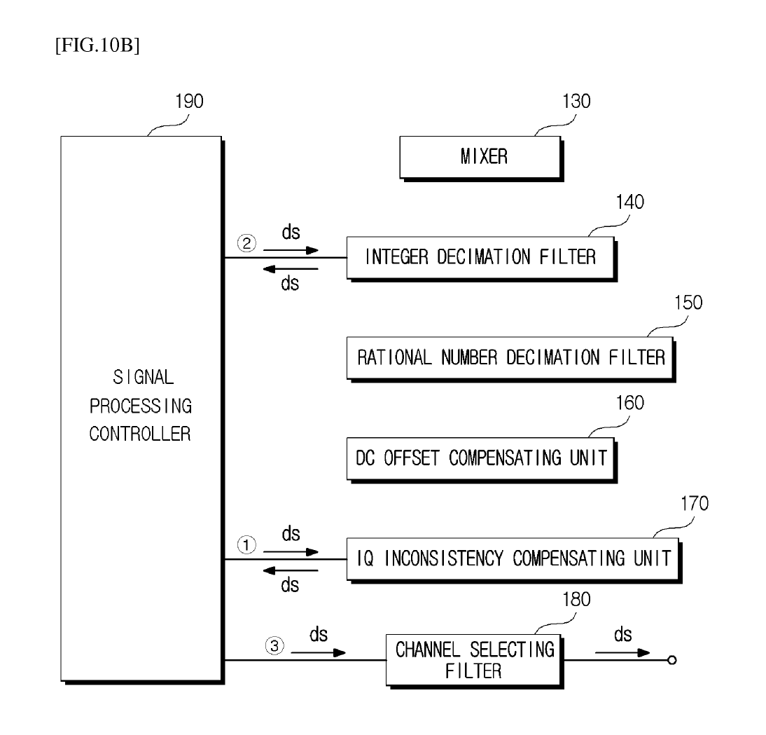

FIGS. 10A and 10B are a control block diagram of a control configuration of the digital RF receiver illustrated in FIG. 1 which is reconfigured according to a ninth exemplary embodiments.

In FIGS. 10A and 10B, detailed description of repeated configurations of the configurations illustrated in FIG. 1 will be omitted or the repeated configurations will be briefly described.

Referring to FIGS. 10A and 10B, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least one of the mixer 130, the integer decimation filter 140, the rational number decimation filter 150, the DC offset compensating unit 160, the IQ inconsistency compensating unit 170, and the channel selecting filter 180 in accordance with an input signal condition of the digital signal ds to control the digital signal ds illustrated in FIG. 1 to be processed.

Here, referring to FIG. 10A, in the input signal condition where the IQs are inconsistent and the digital signal ds does not satisfy an integer sampling rate required in the arbitrary standard, the signal processing controller 190 selects the integer decimation filter 140, the IQ inconsistency compensating unit 170, and the channel selecting filter 180 to process the digital signal ds in accordance with a set signal processing order.

The signal processing controller 190 transmits the digital signal ds, which is transmitted from the signal converting unit 120, to the integer decimation filter 140 and receives an integer-decimated digital signal ds which satisfies the integer sampling rate required in an arbitrary standard from the integer decimation filter 140.

The signal processing controller 190 transmits the digital signal ds, which is transmitted from the integer decimation filter 140, to the IQ inconsistency compensating unit 170 and the IQ inconsistency compensating unit 170 transmits the digital signal ds in which a phase error of the In-phase signal and the quadrature signal is compensated in the digital signal ds to the signal processing controller 190.

The signal processing controller 190 transmits the digital signal ds, which is transmitted from the IQ inconsistency compensating unit 170, to the channel selecting filter 180.

The channel selecting filter 180 outputs a digital signal ds obtained by removing an interference signal to other processing device.

Here, the interference signal may be a noise signal which is flew in the digital signal ds from at least one of the integer decimation filter 140, the IQ inconsistency compensating unit 170, and the signal processing controller 190.

Also, the interference signal may be an original noise signal included in the RF signal, but the invention is not limited thereto.

Here, referring to FIG. 10B, in the input signal condition where the IQs are inconsistent and the digital signal ds does not satisfy an integer sampling rate required in the arbitrary standard, the signal processing controller 190 selects the integer decimation filter 140, the IQ inconsistency compensating unit 170, and the channel selecting filter 180 to process the digital signal ds in accordance with a set signal processing order.

That is, FIG. 10B illustrates a different signal processing order in the input signal condition which is the same as FIG. 10A.

Differently from FIG. 10A, in FIG. 10B, the phase error of the In-phase signal and the quadrature signal is compensated in the IQ inconsistency compensating unit 170, and the digital signal ds is integer-decimated in the integer decimation filter 140, and then transmitted to the channel selecting filter 180.

In FIGS. 10A and 10B, even though it is described that the integer decimation filter 140, the IQ inconsistency compensating unit 170, and the channel selecting filter 180 receive the digital signal ds through the signal processing controller 190, the signal processing controller 190 does not receive the digital signal ds output from at least one of the integer decimation filter 140, the IQ inconsistency compensating unit 170, and the channel selecting filter 180, but controls the digital signal ds to be automatically transmitted to the integer decimation filter 140, the IQ inconsistency compensating unit 170, and the channel selecting filter 180 in accordance with the set signal processing order. However, the invention is not limited thereto.

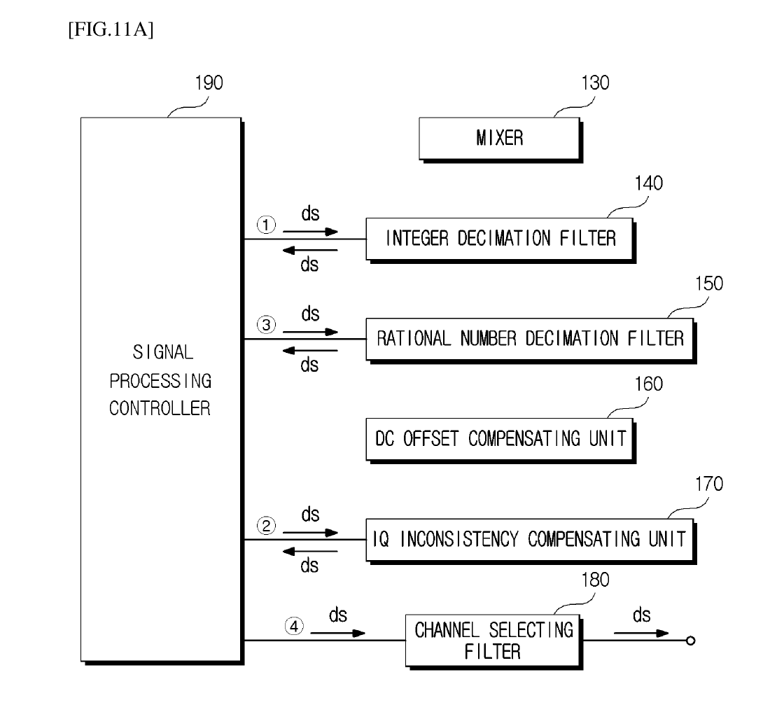

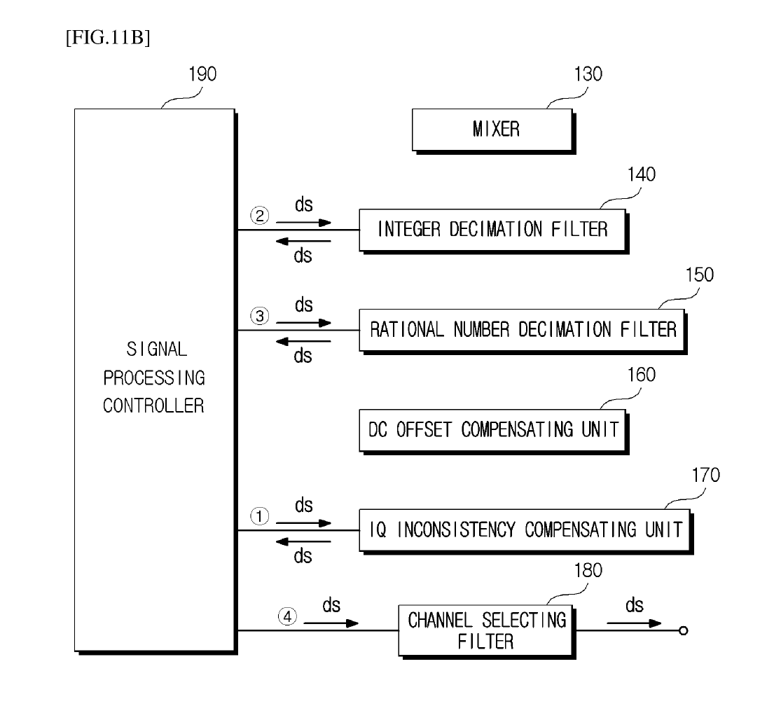

FIGS. 11A and 11B are a control block diagram of a control configuration of the digital RF receiver illustrated in FIG. 1 which is reconfigured according to a tenth exemplary embodiments.

In FIGS. 11A and 11B, detailed description of repeated configurations of the configurations illustrated in FIG. 1 will be omitted or the repeated configurations will be briefly described.

Referring to FIGS. 11A and 11B, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least one of the mixer 130, the integer decimation filter 140, the rational number decimation filter 150, the DC offset compensating unit 160, the IQ inconsistency compensating unit 170, and the channel selecting filter 180 in accordance with an input signal condition of the digital signal ds illustrated in FIG. 1 to control the digital signal ds to be processed.

Here, referring to FIG. 11A, in the input signal condition where the IQs are inconsistent and the digital signal ds does not satisfy a rational number sampling rate required in the arbitrary standard, the signal processing controller 190 selects the integer decimation filter 140, the rational number decimation filter 150, the IQ inconsistency compensating unit 170, and the channel selecting filter 180 to process the digital signal ds in accordance with a set signal processing order.

The signal processing controller 190 transmits the digital signal ds, which is transmitted from the signal converting unit 120, to the integer decimation filter 140 and receives an integer-decimated digital signal ds which satisfies the integer sampling rate required in an arbitrary standard, from the integer decimation filter 140.

The signal processing controller 190 transmits the digital signal ds, which is transmitted from the integer decimation filter 140, to the IQ inconsistency compensating unit 170 and the IQ inconsistency compensating unit 170 transmits the digital signal ds in which a phase error of the In-phase signal and the quadrature signal is compensated in the digital signal ds to the signal processing controller 190.

Thereafter, the signal processing controller 190 transmits the digital signal ds, which is transmitted from the IQ inconsistency compensating unit 170, to the rational number decimation filter 150.

The rational number decimation filter 150 performs the rational number decimation on the digital signal ds to transmit the rational number-decimated digital signal ds to the signal processing controller 190 and the signal processing controller 190 transmits the digital signal ds transmitted from the rational number decimation filter 150 to the channel selecting filter 180.

The channel selecting filter 180 outputs a digital signal ds obtained by removing an interference signal to other processing device.

Here, the interference signal may be a noise signal which is flew in the digital signal ds from at least one of the integer decimation filter 140, the rational number decimation filter 150, the IQ inconsistency compensating unit 170, and the signal processing controller 190.

Also, the interference signal may be an original noise signal included in the RF signal, but the invention is not limited thereto.

Here, referring to FIG. 11B, in the input signal condition where the IQs are inconsistent and the digital signal ds does not satisfy a rational number sampling rate required in the arbitrary standard, the signal processing controller 190 selects the integer decimation filter 140, the rational number decimation filter 150, the IQ inconsistency compensating unit 170, and the channel selecting filter 180 to process the digital signal ds in accordance with a set signal processing order.

That is, FIG. 11B illustrates a different signal processing order in the input signal condition which is the same as FIG. 11A.

Differently from FIG. 11A, in FIG. 11B, the phase error of the In-phase signal and the quadrature signal is compensated in the IQ inconsistency compensating unit 170, and the digital signal ds is integer-decimated in the integer decimation filter 140, rational number-decimated in the rational number decimation filter 150, and then transmitted to the channel selecting filter 180.

In FIGS. 11A and 11B, even though it is described that the integer decimation filter 140, the rational number decimation filter 150, the IQ inconsistency compensating unit 170, and the channel selecting filter 180 receive the digital signal ds through the signal processing controller 190, the signal processing controller 190 does not receive the digital signal ds output from at least one of the integer decimation filter 140, the rational number decimation filter 150, the IQ inconsistency compensating unit 170, and the channel selecting filter 180, but controls the digital signal ds to be automatically transmitted to the integer decimation filter 140, the rational number decimation filter 150, the IQ inconsistency compensating unit 170, and the channel selecting filter 180 in accordance with the set signal processing order. However, the invention is not limited thereto.

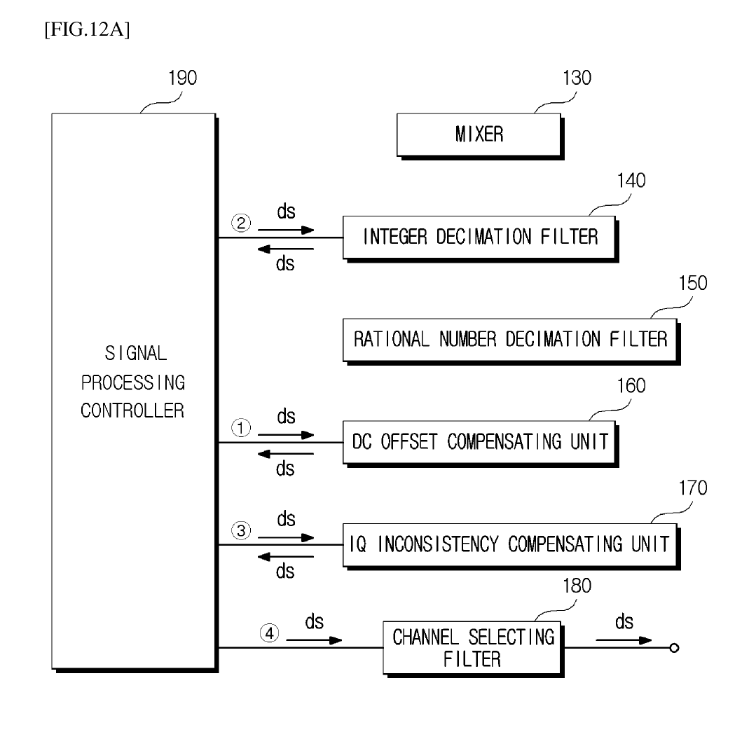

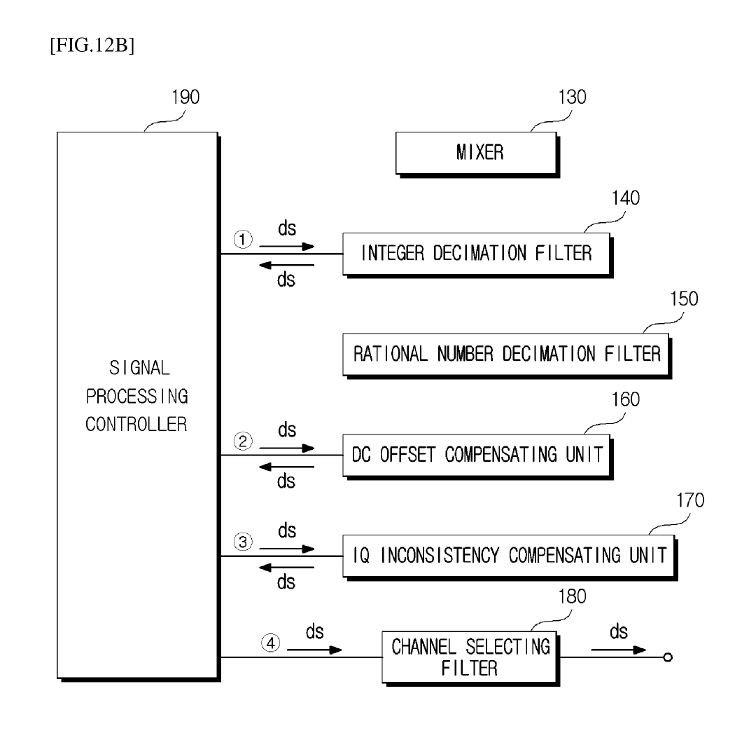

FIGS. 12A and 12B are a control block diagram of a control configuration of the digital RF receiver illustrated in FIG. 1 which is reconfigured according to a ninth exemplary embodiments.

In FIGS. 12A and 12B, detailed description of repeated configurations of the configurations illustrated in FIG. 1 will be omitted or the repeated configurations will be briefly described.

Referring to FIGS. 12A and 12B, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least one of the mixer 130, the integer decimation filter 140, the rational number decimation filter 150, the DC offset compensating unit 160, the IQ inconsistency compensating unit 170, and the channel selecting filter 180 in accordance with an input signal condition of the digital signal ds illustrated in FIG. 1 to control the digital signal ds to be processed.

Here, referring to FIG. 12A, in the input signal condition where the digital signal ds includes a DC component, the IQs are inconsistent, and an integer sampling rate required in the arbitrary standard is not satisfied, the signal processing controller 190 selects the integer decimation filter 140, the DC offset compensating unit 160, the IQ inconsistency compensating unit 170, and the channel selecting filter 180 to process the digital signal ds in accordance with a set signal processing order.

The signal processing controller 190 transmits the digital signal ds, which is transmitted from the signal converting unit 120, to the DC offset compensating unit 160 and receives a digital signal ds in which the DC component is removed from the DC offset compensating unit 160.

The signal processing controller 190 transmits the digital signal ds, which is transmitted from the DC offset compensating unit 160, to the integer decimation filter 140 and receives an integer-decimated digital signal ds which satisfies the integer sampling rate required in an arbitrary standard, from the integer decimation filter 140.

The signal processing controller 190 transmits the digital signal ds, which is transmitted from the integer decimation filter 140, to the IQ inconsistency compensating unit 170 and the IQ inconsistency compensating unit 170 transmits the digital signal ds in which a phase error of the In-phase signal and the quadrature signal is compensated in the digital signal dsto the signal processing controller 190.

The signal processing controller 190 transmits the digital signal ds, which is transmitted from the IQ inconsistency compensating unit 170, to the channel selecting filter 180.

The channel selecting filter 180 outputs a digital signal ds obtained by removing an interference signal to other processing device.

Here, the interference signal may be a noise signal which is flew in the digital signal ds from at least one of the integer decimation filter 140, the DC offset compensating unit 160, the IQ inconsistency compensating unit 170, and the signal processing controller 190.

Also, the interference signal may be an original noise signal included in the RF signal, but the invention is not limited thereto.

Here, referring to FIG. 12B, in the input signal condition where the digital signal ds includes a DC component, the IQs are inconsistent, and an integer sampling rate required in the arbitrary standard is not satisfied, the signal processing controller 190 selects the integer decimation filter 140, the DC offset compensating unit 160, the IQ inconsistency compensating unit 170, and the channel selecting filter 180 to process the digital signal ds in accordance with a set signal processing order.

That is, FIG. 12B illustrates a different signal processing order in the input signal condition which is the same as FIG. 12A.

Differently from FIG. 12A, in FIG. 12B, the integer decimation is performed on a digital signal ds first in the integer decimation filter 140, the DC component is removed in the DC offset compensating unit 160, the phase error of the In-phase signal and the quadrature signal is compensated in the IQ inconsistency compensating unit 170, and then the digital signal ds is transmitted to the channel selecting filter 180.

In FIGS. 12A and 12B, even though it is described that the integer decimation filter 140, the DC offset compensating unit 160, the IQ inconsistency compensating unit 170, and the channel selecting filter 180 receive the digital signal ds through the signal processing controller 190, the signal processing controller 190 does not receive the digital signal ds output from at least one of the integer decimation filter 140, the DC offset compensating unit 160, the IQ inconsistency compensating unit 170, and the channel selecting filter 180, but controls the digital signal to be automatically transmitted to the integer decimation filter 140, the DC offset compensating unit 160, the IQ inconsistency compensating unit 170, and the channel selecting filter 180 in accordance with the set signal processing order. However, the invention is not limited thereto.

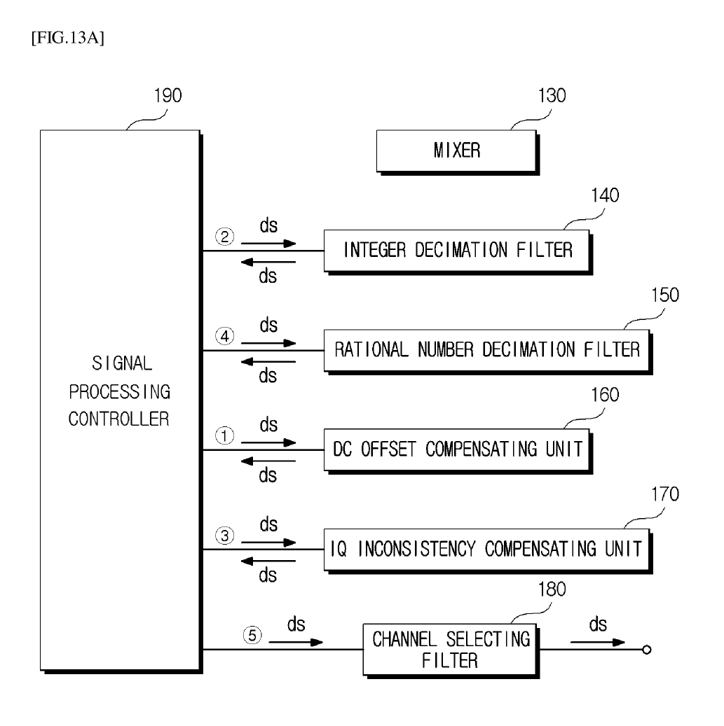

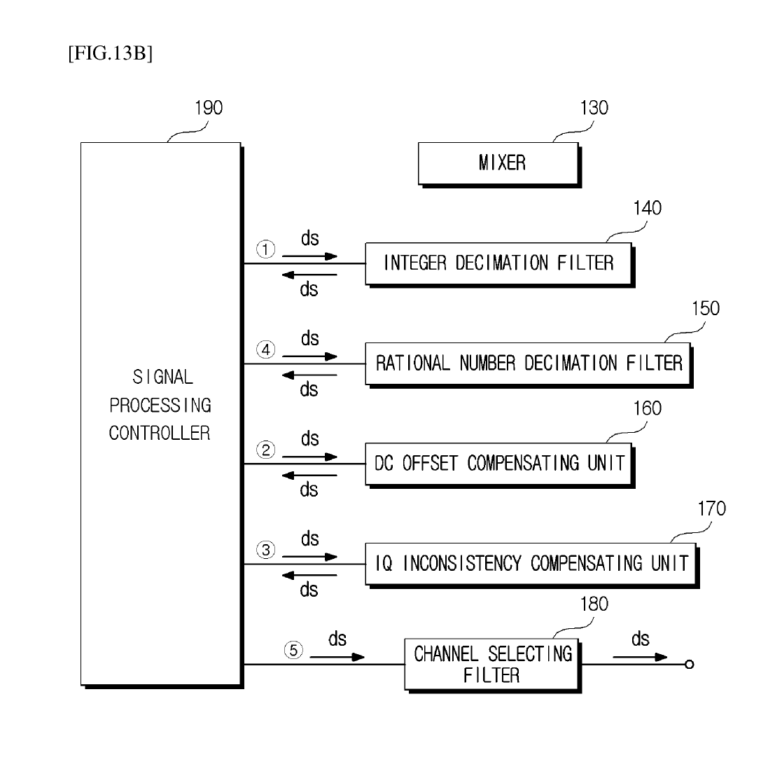

FIGS. 13A and 13B are a control block diagram of a control configuration of the digital RF receiver illustrated in FIG. 1 which is reconfigured according to a twelfth exemplary embodiments.

In FIGS. 13A and 13B, detailed description of repeated configurations of the configurations illustrated in FIG. 1 will be omitted or the repeated configurations will be briefly described.

Referring to FIGS. 13A and 13B, the digital RF receiver may include the low noise amplifier 110, the signal converting unit 120, the mixer 130, the integer decimation filter 140, the rational number decimation filter 150, the DC offset compensating unit 160, the IQ inconsistency compensating unit 170, the channel selecting filter 180, and the signal processing controller 190.

The signal processing controller 190 selects at least one of the mixer 130, the integer decimation filter 140, the rational number decimation filter 150, the DC offset compensating unit 160, the IQ inconsistency compensating unit 170, and the channel selecting filter 180 in accordance with an input signal condition of the digital signal ds illustrated in FIG. 1 to control the digital signal ds to be processed.

Here, referring to FIG. 13A, in the input signal condition where the digital signal ds includes the DC component, the IQs are inconsistent but a rational number sampling rate required in the arbitrary standard is not satisfied, the signal processing controller 190 selects the integer decimation filter 140, the rational number decimation filter 150, the DC offset compensating unit 160, the IQ inconsistency compensating unit 170, and the channel selecting filter 180 to process the digital signal ds in accordance with a set signal processing order.

The signal processing controller 190 transmits the digital signal ds, which is transmitted from the signal converting unit 120, to the DC offset compensating unit 160 and receives a digital signal ds in which the DC component is removed from the DC offset compensating unit 160.

The signal processing controller 190 transmits the digital signal ds, which is transmitted from the DC offset compensating unit 160, to the integer decimation filter 140 and receives an integer-decimated digital signal ds which satisfies the integer sampling rate required in an arbitrary standard from the integer decimation filter 140.

The signal processing controller 190 transmits the digital signal ds, which is transmitted from the integer decimation filter 140, to the IQ inconsistency compensating unit 170 and the IQ inconsistency compensating unit 170 transmits the digital signal ds in which a phase error of the In-phase signal and the quadrature signal is compensated in the digital signal ds to the signal processing controller 190.

Further, the signal processing controller 190 transmits the digital signal ds, which is transmitted from the IQ inconsistency compensating unit 170, to the rational number decimation filter 150.

The rational number decimation filter 150 performs the rational number decimation on the digital signal ds to transmit the rational number-decimated digital signal to the signal processing controller 190 and the signal processing controller 190 transmits the digital signal ds transmitted from the rational number decimation filter 150 to the channel selecting filter 180.

The channel selecting filter 180 outputs a digital signal ds obtained by removing an interference signal to other processing device.

Here, the interference signal may be a noise signal which is flew in the digital signal ds from at least one of the integer decimation filter 140, the rational number decimation filter 150, the IQ inconsistency compensating unit 170, and the signal processing controller 190.

Also, the interference signal may be an original noise signal included in the RF signal, but the invention is not limited thereto.

Here, referring to FIG. 13B, in the input signal condition where the digital signal ds includes the DC component and the IQs are inconsistent but a rational number sampling rate required in the arbitrary standard is not satisfied, the signal processing controller 190 selects the integer decimation filter 140, the rational number decimation filter 150, the DC offset compensating unit 160, the IQ inconsistency compensating unit 170, and the channel selecting filter 180 to process the digital signal ds in accordance with a set signal processing order.

That is, FIG. 13B illustrates a different signal processing order in the input signal condition which is the same as FIG. 13A.

Differently from FIG. 13A, in FIG. 13B, the integer decimation is performed on a digital signal ds first in the integer decimation filter 140, the DC component is removed in the DC offset compensating unit 160, the phase error of the In-phase signal and the quadrature signal is compensated in the IQ inconsistency compensating unit 170, the digital signal ds is rational-number decimated in the rational number decimation filter 150 and then is transmitted to the channel selecting filter 180.

In FIGS. 13A and 13B, even though it is described that the integer decimation filter 140, the rational number decimation filter 150, the DC offset compensating unit 160, the IQ inconsistency compensating unit 170, and the channel selecting filter 180 receive the digital signal ds through the signal processing controller 190, the signal processing controller 190 does not receive the digital signal ds output from at least one of the integer decimation filter 140, the rational number decimation filter 150, the DC offset compensating unit 160, the IQ inconsistency compensating unit 170, and the channel selecting filter 180, but controls the digital signal ds to be automatically transmitted to the integer decimation filter 140, the rational number decimation filter 150, the DC offset compensating unit 160, the IQ inconsistency compensating unit 170, and the channel selecting filter 180 in accordance with the set signal processing order. However, the invention is not limited thereto.

The control configuration of the digital RF receiver according to the exemplary embodiments illustrated in FIGS. 2 to 13 has an advantage in that the signal processing order is determined in accordance with the input signal condition of the RF signal or the digital signal among the control configuration of the digital RF receiver illustrated in FIG. 1 and the signal is processed to reduce power consumption and a signal processing time.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A digital RF receiver, comprising: a signal converting unit which converts an RF signal received from an external device into a digital signal;
a plurality of functional modules which processes the digital signal in accordance with a predetermined algorithm when the digital signal is input; and
a signal processing controller which selects at least one of the plurality of functional modules to control the digital signal to be processed in consideration of whether an IF signal component is included in the digital signal or a sampling rate related with sampling information of the digital signal.

2. The digital RF receiver of claim 1, wherein:
the plurality of functional modules, includes
a DC offset compensating unit which removes a DC component included in the digital signal;
an IQ inconsistency compensating unit which compensates a phase error of an In-phase signal and a quadrature signal of the digital signal;
a mixer which removes the IF signal from the digital signal and separates a phase;
an integer decimation filter which performs integer decimation so as to satisfy an integer sampling rate required for sampling information of the digital signal;
a rational number decimation filter which performs rational decimation so as to satisfy a rational number sampling rate of the digital signal; and
a signal processing unit which includes a channel selecting filter which removes an interference signal from the digital signal.

3. The digital RF receiver of claim 2, wherein:
when the IF signal component is included in the digital signal and the sampling rate of the digital signal does not satisfy a predetermined integer sampling rate, the signal processing controller selects the mixer, the integer decimation filter, and the channel selecting filter and outputs the digital signal to the mixer, the integer decimation filter, and the channel selecting filter in accordance with a predetermined order.

4. The digital RF receiver of claim 2, wherein:
when the IF signal component is included in the digital signal and the sampling rate of the digital signal does not satisfy a predetermined rational number sampling rate, the signal processing controller selects the mixer, the integer decimation filter, the rational number decimation filter, and the channel selecting filter and outputs the digital signal to the mixer, the integer decimation filter, the rational number decimation filter, and the channel selecting filter in accordance with a predetermined order.

5. The digital RF receiver of claim 2, wherein:
when the IF signal component and the DC component are included in the digital signal and the sampling rate of the digital signal does not satisfy a predetermined integer sampling rate, the signal processing controller selects the DC offset compensating unit, the mixer, the integer decimation filter, and the channel selecting filter and outputs the digital signal to the DC offset compensating unit, the mixer, the integer decimation filter, and the channel selecting filter in accordance with a predetermined order.

6. The digital RF receiver of claim 2, wherein:
when the IF signal component and the DC component are included in the digital signal and the sampling rate of the digital signal does not satisfy a predetermined rational number sampling rate, the signal processing controller selects the DC offset compensating unit, the mixer, the integer decimation filter, the rational number decimation filter, and the channel selecting filter and outputs the digital signal to the DC offset compensating unit, the mixer, the integer decimation filter, the rational number decimation filter, and the channel selecting filter in accordance with a predetermined order.

7. The digital RF receiver of claim 2, wherein:
when the IF signal component is included in the digital signal and the sampling rate of the digital signal does not satisfy a predetermined integer sampling rate, the signal processing controller selects the IQ inconsistency compensating unit, the mixer, the integer decimation filter, and the channel selecting filter and outputs the digital signal to the IQ inconsistency compensating unit, the mixer, the integer decimation filter, and the channel selecting filter in accordance with a predetermined order.

8. The digital RF receiver of claim 2, wherein:
when the IF signal component is included in the digital signal, the IQs are inconsistent, and the sampling rate of the digital signal does not satisfy a predetermined rational number sampling rate, the signal processing controller selects the IQ inconsistency compensating unit, the mixer, the integer decimation filter, the rational number decimation filter, and the channel selecting filter and outputs the digital signal to the IQ inconsistency compensating unit, the mixer, the integer decimation filter, the rational number decimation filter, and the channel selecting filter in accordance with a predetermined order.

9. The digital RF receiver of claim 2, wherein:
when the IF signal component and the DC component are included in the digital signal, the IQs are inconsistent, and the sampling rate of the digital signal does not satisfy a predetermined integer sampling rate, the signal processing controller selects the DC offset compensating unit, the IQ inconsistency compensating unit, the mixer, the integer decimation filter, and the channel selecting filter and outputs the digital signal to the DC offset compensating unit, the IQ inconsistency compensating unit, the mixer, the integer decimation filter, and the channel selecting filter in accordance with a predetermined order.

10. The digital RF receiver of claim 2, wherein:
when the IF signal component and the DC component are included in the digital signal, the IQs are inconsistent, and the sampling rate of the digital signal does not satisfy a predetermined rational number sampling rate, the signal processing controller selects the DC offset compensating unit, the IQ inconsistency compensating unit, the mixer, the integer decimation filter, the rational number decimation filter, and the channel selecting filter and outputs the digital signal to the DC offset compensating unit, the IQ inconsistency compensating unit, the mixer, the integer decimation filter, the rational number decimation filter, and the channel selecting filter in accordance with a predetermined order.

11. The digital RF receiver of claim 2, wherein:
when the IQs of the digital signal are inconsistent and the sampling rate of the digital signal does not satisfy a predetermined integer sampling rate, the signal processing controller selects the integer decimation filter, the IQ inconsistency compensating unit, and the channel selecting filter and outputs the digital signal to the integer decimation filter, the IQ inconsistency compensating unit, and the channel selecting filter in accordance with a predetermined order.

12. The digital RF receiver of claim 2, wherein:
when the IQs of the digital signal are inconsistent and the sampling rate of the digital signal does not satisfy a predetermined rational number sampling rate, the signal processing controller selects the integer decimation filter, the IQ inconsistency compensating unit, the rational number decimation filter, and the channel selecting filter and outputs the digital signal to the integer decimation filter, the IQ inconsistency compensating unit, the rational number decimation filter, and the channel selecting filter in accordance with a predetermined order.

13. The digital RF receiver of claim 2, wherein:
when the DC component is included in the digital signal, the IQs are inconsistent, and the sampling rate of the digital signal does not satisfy a predetermined integer sampling rate, the signal processing controller selects the DC offset compensating unit, the integer decimation filter, the IQ inconsistency compensating unit, and the channel selecting filter and outputs the digital signal to the DC offset compensating unit, the integer decimation filter, the IQ inconsistency compensating unit, and the channel selecting filter in accordance with a predetermined order.

14. The digital RF receiver of claim 2, wherein:
when the DC component is included in the digital signal, the IQs are inconsistent, and the sampling rate of the digital signal does not satisfy a predetermined rational number sampling rate, the signal processing controller selects the DC offset compensating unit, the integer decimation filter, the IQ inconsistency compensating unit, the rational number decimation filter, and the channel selecting filter and outputs the digital signal to the DC offset compensating unit, the integer decimation filter, the IQ inconsistency compensating unit, the rational number decimation filter, and the channel selecting filter in accordance with a predetermined order.
